(19) United States
(12) Patent Application Publication
(10) Pub. No.: US 2012/0011729 A1
(43) Pub. Date: Jan. 19, 2012

(54) ELECTRIC PRUNING SHEARS EQUIPPED WITH TRIGGER

(75) Inventors: You Jung Kim, Daejeon (KR); Jin Ho Kim, Daejeon (KR)

(73) Assignee: ROA TECHNOLOGY CO., LTD., Daejeon (KR)

(21) Appl. No.: 13/258,615

(22) PCT Filed: Jul. 22, 2009
(86) PCT No.: PCT/KR2009/004067

§ 371 Date: Sep. 22, 2011

(30) Foreign Application Priority Data
Mar. 23, 2009 (KR) 10-2009-0024582

(51) Int. Cl. A01G 3/037

(52) U.S. Cl. 30/228

(57) ABSTRACT

Electric pruning shears equipped with a trigger provided where the trigger could operate a motor assembly by detecting magnetic polarity with a polarity detecting sensor, transmitting an operating signal in accordance with the polarity to the control assembly, determining whether the corresponding signal is in the reverse or forward direction, and transmitting the determined reverse driving signal or forward driving signal to the motor assembly to operate a motor, and also the trigger allows a movable blade to stop at a desired position on a branch while pruning fruit trees by stopping the operation of the motor if the polarity detecting sensor realizes the magnetic center.

### BACKGROUND OF THE INVENTION

The present invention relates to electric pruning shears equipped with a trigger, more specifically, wherein the trigger could operate a motor assembly by detecting magnetic polarity with a polarity detecting sensor, transmitting an operating signal in accordance with the polarity to the control assembly, determining whether the corresponding signal is in the reverse or forward direction, and transmitting the determined reverse driving signal or forward driving signal to the motor assembly to operate a motor, and also the trigger allows a movable blade to stop at a desired position on a branch while pruning fruit trees by stopping the operation of the motor if the polarity detecting sensor realizes the magnetic center.

Conventional electric shears serves to cut thin portions of a paper or a fabric etc. as an art and craft instrument for child.

Accordingly, the conventional electric shears cannot cut the thick branches of the fruit trees. Also, there is a problem in that the shears is continuously operated during the closing of the switch, thereby consuming an enormous amount of power. Moreover, as though the switch is open and then, the motor is stopped, it cannot check whether the shears is open or close, or the shears stop in mid-location thereof.

Accordingly, the conventional electric shears cannot utilize as an electric pruning shears for fruit trees.

Generally, since the electric pruning shears for fruit trees is operated through the power of the worker's wrist to cut the branches thereof, there are problems in that the feeling of fatigue is increased and the operation efficiency is remarkably decreased.

Also, in the conventional electric shears, since the branches of the fruit trees are cut through the power of the worker and it is difficult to cut thick branches, the wrist or body of the worker can get easily tired and it spend much time on the working thereof.

Also, during the cutting work of the branches, since it cannot stop the operation of the motor, the branch can be wrongly cut.

### SUMMARY OF THE INVENTION

Therefore, the present invention has been made in view of the above-mentioned problems, and the object of the present invention is to provide electric pruning shears equipped with a trigger, wherein the trigger could operate a motor assembly by detecting magnetic polarity with a polarity detecting sensor, transmitting an operating signal in accordance with the polarity to the control assembly, determining whether the corresponding signal is in the reverse or forward direction, and transmitting the determined reverse driving signal or forward driving signal to the motor assembly to operate a motor, and also the trigger allows a movable blade to stop at a desired position on a branch while pruning fruit trees by stopping the operation of the motor if the polarity detecting sensor realizes the magnetic center.

Another object of the present invention is to provide electric pruning shears equipped with a trigger in that, where the overload is occurred during working thereof, a control assembly detects it and then, transmits the operation stop signal to a motor assembly to stop the driving of the motor assembly, thereby it can prevent the control assembly, the battery, and the motor assembly from being damaged.

Another object of the present invention is to provide electric pruning shears equipped with a trigger in that a gear assembly is coupled to a ball screw and a plurality of balls is inserted into the inside of a nut for converting the rotary motion of the ball screw into the rectilineal movement, so that it can prevent the ball screw and the nut from being damaged.

Further another object of the present invention is to provide electric pruning shears equipped with a trigger in that the body includes a display portion, so that the residual quantity of a battery can be displayed, thereby it can provide the charge time to the worker.

Further another object of the present invention is to provide electric pruning shears equipped with a trigger in that a connector is constructed to the body and the mechanical section and the body is coupled to and separated from the mechanical section through a connector cable, so that the separated connector cable is kept for a long time, thereby extending the life span of the battery.

Further another object of the present invention is to provide electric pruning shears equipped with a trigger in that the gear assembly includes three internal gears and an external gear for protecting the internal gears and a motor shaft gear is engaged with the center of three internal gears, thereby converting the speed of the motor assembly into the power and more increasing the cutting capacity thereof.

In accordance with the present invention to achieve the object thereof, there is provided electric pruning shears equipped with a trigger comprising: a mechanical section comprising a motor assembly having a motor shaft gear formed at one side thereof, a gear assembly interlocked with the motor shaft gear, a ball screw coupled to the gear assembly and rotated in a conrotatory direction of the gear assembly, a nut coupled to the ball screw and converting a rotary motion of the ball screw into a rectilineal movement, a polarity detecting sensor formed on an upper portion of a nut cap for covering an outside of the nut and detecting a polarity of a magnet, the magnet having polarity and formed on a lower portion of the polarity detecting sensor, a spring formed at one side of the magnet, a trigger coupled to the nut, a connecting bar having one side coupled to the nut and another side coupled to a movable blade, the movable blade for moving up and down according to the rectilineal movement of the connecting bar, and a fixing blade fixed to a case; and a body comprising a control assembly for receiving a polarity signal detected by the polarity detecting sensor, determining whether the detected signal is a reverse direction, a forward direction, or an operation stop, and transmitting a forward driving signal, a reverse driving signal, or an operation stop signal to the motor assembly; a power switch; and a battery for supplying a power source to the control assembly.

According to the electric pruning shears equipped with the trigger as described above, there is an effect in that instead of the conventional forward and reverse operating switch, the magnet coupled to the trigger can be moved in accordance with the operation of the trigger through the user, so that the trigger could operate the motor assembly by detecting magnetic polarity with the polarity detecting sensor, transmitting the operating signal in accordance with the polarity to the control assembly, determining whether the corresponding signal is in the reverse or forward direction, and transmitting the determined reverse driving signal or forward driving signal to the motor assembly to operate a motor, and also the trigger allows a movable blade to stop at a desired position on a branch while pruning fruit trees by stopping the operation of the motor if the polarity detecting sensor realizes the magnetic center.

Also, where the overload is occurred during working thereof, a control assembly detects it and then, transmits the operation stop signal to a motor assembly to stop the driving of the motor assembly, thereby it can prevent the control assembly, the battery, and the motor assembly from being damaged.

Moreover, a gear assembly is coupled to a ball screw and a plurality of balls is inserted into the inside of a nut for converting the rotary motion of the ball screw into the rectilineal movement, so that it can prevent the ball screw and the nut from being damaged.

Furthermore, the body includes a display portion, so that the residual quantity of a battery can be displayed, thereby it can provide the charge time to the worker.

Also, the connector is constructed to the body and the mechanical section and the body is coupled to and separated from the mechanical section through a connector cable, so that the separated connector cable is kept for a long time, thereby extending the life span of the battery.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a perspective view illustrating electric pruning shears equipped with a trigger according to the present invention;

FIG. 2 is a sectional view illustrating a mechanical section of electric pruning shears equipped with a trigger according to the present invention;

FIG. 3 is a sectional view illustrating a motor assembly, a gear assembly, and a ball screw of electric pruning shears equipped with a trigger according to the present invention;

FIG. 4 is an internal sectional view illustrating a mechanical section of electric pruning shears equipped with a trigger according to the present invention;

FIG. 5 is a sectional view illustrating a body of electric pruning shears equipped with a trigger according to the present invention;

FIG. 6 is an example view illustrating a state of a magnet before a trigger according to the present invention is pulled; and

FIG. 7 is an example view illustrating a state of a magnet after a trigger according to the present invention is pulled.

### DESCRIPTIONS ON REFERENCE NUMBERS FOR THE MAJOR COMPONENTS IN THE DRAWINGS

| | |
|---|---|
| 100: mechanical section | 110: motor assembly |
| 115: motor shaft gear | 120: gear assembly |
| 130: ball screw | 140: nut |
| 150: polarity detecting sensor | 160: magnet |
| 170: spring | 190: connecting bar |
| 195: movable blade | 196: case |
| 197: fixing blade 197 fixed to a case 196. | |
| 200: body | 210: battery |
| 220: control assembly | 230: power switch |
| 240: display portion | 250: connector |
| 260: charge connector | 300: connector |

### DETAILED DESCRIPTION OF THE INVENTION

Hereinafter, exemplary embodiments of the present invention will be described in detail with reference to the accompanying drawings.

In accordance with an aspect of the present invention to achieve the object thereof, there is provided electric pruning shears equipped with a trigger comprising: a mechanical section comprising a motor assembly having a motor shaft gear formed at one side thereof, a gear assembly interlocked with the motor shaft gear, a ball screw coupled to the gear assembly and rotated in a conrotatory direction of the gear assembly, a nut coupled to the ball screw and converting a rotary motion of the ball screw into a rectilineal movement, a polarity detecting sensor formed on an upper portion of a nut cap for covering an outside of the nut and detecting a polarity of a magnet, the magnet having polarity and formed on a lower portion of the polarity detecting sensor, a spring formed at one side of the magnet, a trigger coupled to the nut, a connecting bar having one side coupled to the nut and another side coupled to a movable blade, the movable blade for moving up and down according to the rectilineal movement of the connecting bar, and a fixing blade fixed to a case; and a body comprising a control assembly for receiving a polarity signal detected by the polarity detecting sensor, determining whether the detected signal is a reverse direction, a forward direction, or an operation stop, and transmitting a forward driving signal, a reverse driving signal, or an operation stop signal to the motor assembly; a power switch; and a battery for supplying a power source to the control assembly.

In accordance with another aspect of the present invention to achieve the object thereof, there is provided electric pruning shears equipped with a trigger comprising:a mechanical section comprising a motor assembly having a motor shaft gear formed at one side thereof, a gear assembly interlocked with the motor shaft gear, a ball screw coupled to the gear assembly and rotated in a conrotatory direction of the gear assembly, a nut coupled to the ball screw and converting a rotary motion of the ball screw into a rectilineal movement, a polarity detecting sensor formed on an upper portion of a nut cap for covering an outside of the nut and detecting a polarity of a magnet, the magnet having polarity and formed on a lower portion of the polarity detecting sensor, a spring formed at one side of the magnet, a trigger coupled to the nut, a connecting bar having one side coupled to the nut and another side coupled to a movable blade, the movable blade for moving up and down according to the rectilineal movement of the connecting bar, and a fixing blade fixed to a case; and a body comprising a control assembly for receiving a polarity signal detected by the polarity detecting sensor, determining whether the detected signal is a reverse direction, a forward direction, or an operation stop, and transmitting a forward driving signal, a reverse driving signal or an operation stop signal to the motor assembly, or transmitting an operation stop signal to the motor assembly when an over-current detecting signal is received from an over-current detecting portion; a power switch; a battery for supplying a power source to the control assembly; and the over-current detecting portion for detecting the over-current when the over-current is generated in the motor assembly.

In accordance with further another aspect of the present invention to achieve the object thereof, there is provided electric pruning shears equipped with a trigger comprising: a mechanical section comprising a motor assembly having a motor shaft gear formed at one side thereof, a gear assembly interlocked with the motor shaft gear, a ball screw coupled to the gear assembly and rotated in a conrotatory direction of the gear assembly, a nut coupled to the ball screw and converting a rotary motion of the ball screw into a rectilineal movement, a polarity detecting sensor formed on an upper portion of a nut cap for covering an outside of the nut and detecting a polarity of a magnet, the magnet having polarity and formed on a lower portion of the polarity detecting sensor, a spring formed at one side of the magnet, a trigger coupled to the nut, a connecting bar having one side coupled to the nut and another side coupled to a movable blade, the movable blade for moving up and down according to the rectilineal movement of the connecting bar, and a fixing blade fixed to a case; and a body comprising a control assembly for receiving a polarity signal detected by the polarity detecting sensor, determining whether the detected signal is a reverse direction, a forward direction, or an operation stop, and transmitting a forward driving signal, a reverse driving signal or an operation stop signal to the motor assembly, or transmitting an operation stop signal to the motor assembly when an over-current detecting signal is received from an over-current detecting portion; a power switch; a battery for supplying a power source to the control assembly; the over-current detecting portion for detecting the over-current when the over-current is generated in the motor assembly; and a display portion for displaying the residual quantity of the battery.

At this time, a connector can be constructed to the body and the mechanical section and the body is coupled to and separated from the mechanical section through a connector cable.

Also, the motor assembly is a slotless BLDC type motor so as to smoothly and rapidly operate an instant reverse direction when the trigger is not pulled.

Moreover, a plurality of balls is inserted into the inside of the nut so as to prevent the ball screw and the nut from being damaged.

Furthermore, the control assembly transmits the forward driving signal to the motor assembly when the polarity detected by the polarity detecting sensor is a N-pole, and transmits the reverse driving signal to the motor assembly when the polarity detected by the polarity detecting sensor is a S-pole.

Also, the control assembly transmits the forward driving signal to the motor assembly when the polarity detected by the polarity detecting sensor is a N-pole, transmits the reverse driving signal to the motor assembly when the polarity detected by the polarity detecting sensor is a S-pole, and transmits the operation stop signal to the motor assembly when the polarity detected by the polarity detecting sensor is a non-polarity.

Moreover, the gear assembly comprises three internal gears and an external gear for protecting the internal gears and the motor shaft gear is engaged with the center of the three internal gears.

In the meantime, in accordance with further another aspect of the present invention to achieve the object thereof, there is provided electric pruning shears equipped with a trigger comprising: a mechanical section comprising a gear assembly coupled to a shaft of a motor assembly attached to a case, a nut for converting a rotary motion of the gear assembly into a rectilineal movement, a magnet moved left and right according to a movement of a trigger, and a polarity detecting sensor for detecting a polarity of the magnet and transmitting a detected polarity signal to a control assembly; and a body comprising a control assembly for receiving the polarity signal detected by the polarity detecting sensor, determining whether the detected signal is a reverse direction, a forward direction, or an operation stop, and transmitting a forward driving signal, a reverse driving signal, or an operation stop signal to the motor assembly; a power switch; and a battery for supplying a power source to the control assembly.

In accordance with further another aspect of the present invention to achieve the object thereof, there is provided electric pruning shears equipped with a trigger comprising: a mechanical section comprising a gear assembly coupled to a shaft of a motor assembly attached to a case, a nut for converting a rotary motion of the gear assembly into a rectilineal movement, a magnet moved left and right according to a movement of a trigger, and a polarity detecting sensor for detecting a polarity of the magnet and transmitting a detected polarity signal to a control assembly; and a body comprising a control assembly for receiving the polarity signal detected by the polarity detecting sensor, determining whether the detected signal is a reverse direction, a forward direction, or an operation stop, and transmitting a forward driving signal, a reverse driving signal or an operation stop signal to the motor assembly, or transmitting an operation stop signal to the motor assembly when an over-current detecting signal is received from an over-current detecting portion; a power switch; a battery for supplying a power source to the control assembly; and the over-current detecting portion for detecting the over-current when the over-current is generated in the motor assembly.

At this time, the control assembly transmits the forward driving signal to the motor assembly when the polarity detected by the polarity detecting sensor is a N-pole, and transmits the reverse driving signal to the motor assembly when the polarity detected by the polarity detecting sensor is a S-pole.

Here, the control assembly transmits the forward driving signal to the motor assembly when the polarity detected by the polarity detecting sensor is a N-pole, transmits the reverse driving signal to the motor assembly when the polarity detected by the polarity detecting sensor is a S-pole, and transmits the operation stop signal to the motor assembly when the polarity detected by the polarity detecting sensor is a non-polarity.

Also, the gear assembly comprises three internal gears and an external gear for protecting the internal gears and the motor shaft gear is engaged with the center of the three internal gears.

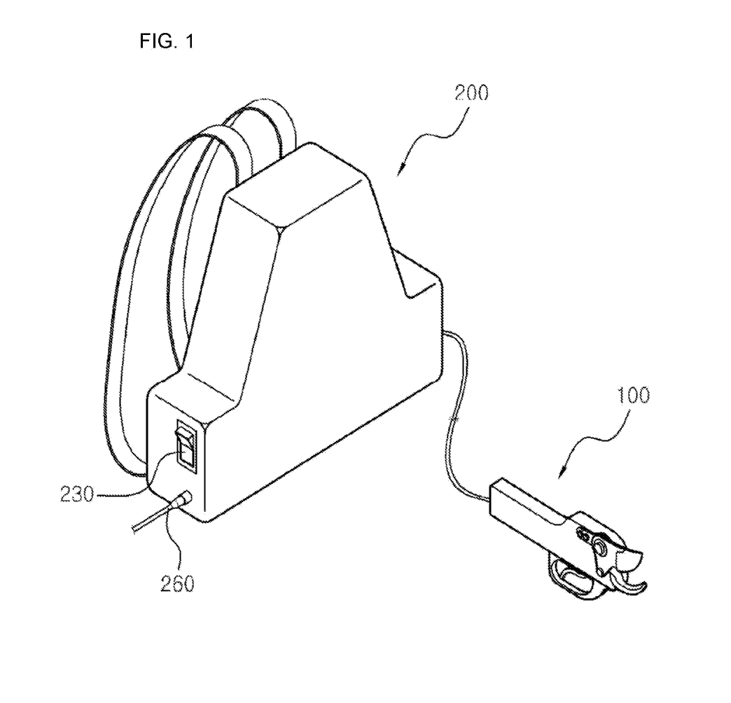

FIG. 1 is a perspective view illustrating electric pruning shears equipped with a trigger according to the present invention.

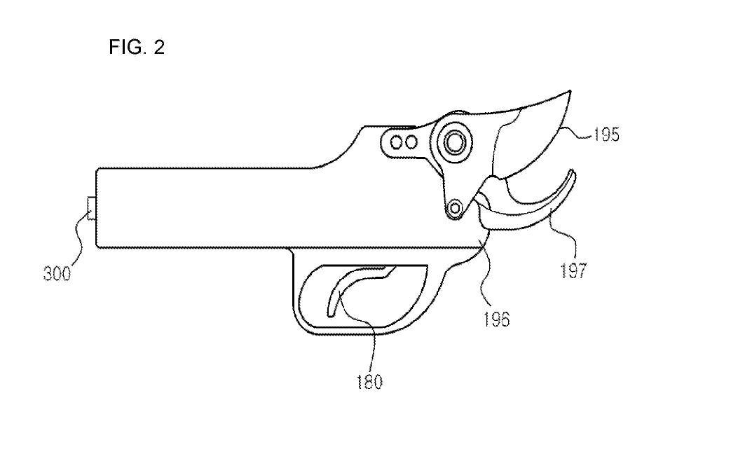

FIG. 2 is a sectional view illustrating a mechanical section of electric pruning shears equipped with a trigger according to the present invention.

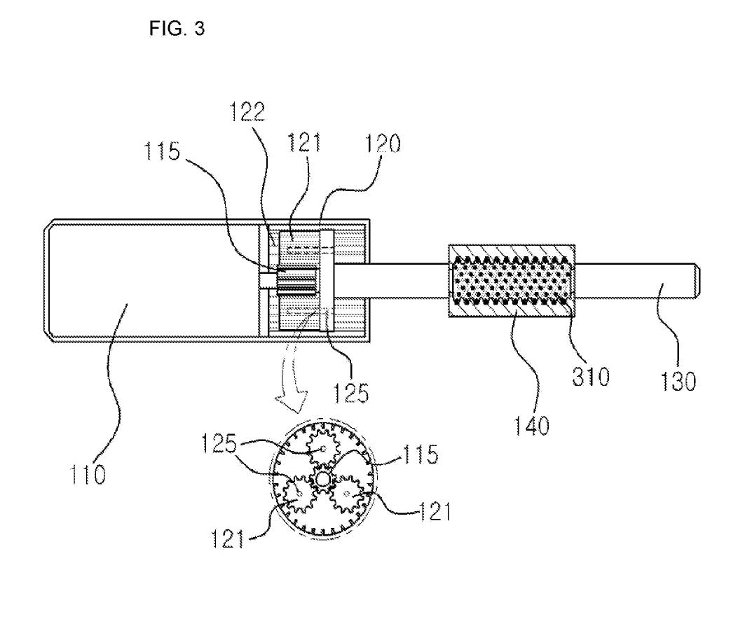

FIG. 3 is a sectional view illustrating a motor assembly, a gear assembly, and a ball screw of electric pruning shears equipped with a trigger according to the present invention.

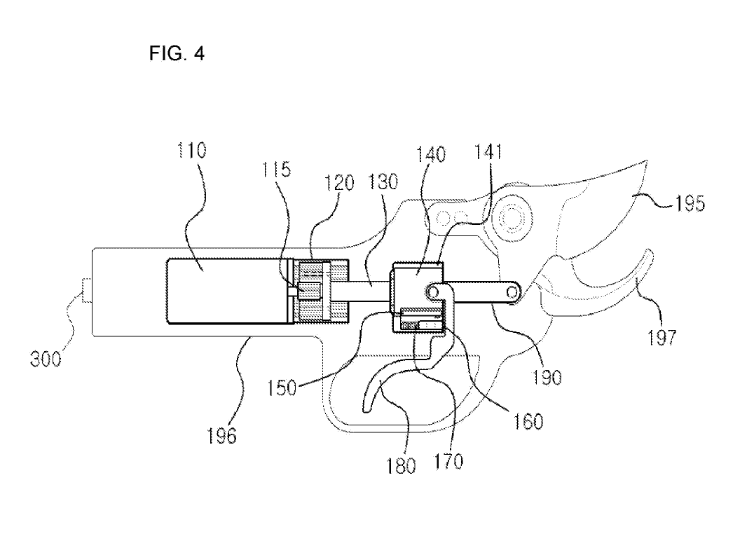

FIG. 4 is an internal sectional view illustrating a mechanical section of electric pruning shears equipped with a trigger according to the present invention.

As shown in FIG. 1, the electric pruning shears equipped with a trigger according to the present invention includes a mechanical section 100 and a body 200.

The mechanical section 100 includes a motor assembly 110 having a motor shaft gear 115 formed at one side thereof, a gear assembly 120 interlocked with the motor shaft gear 115, a ball screw 130 coupled to the gear assembly and rotated in a conrotatory direction of the gear assembly, a nut 140 coupled to the ball screw 130 and converting a rotary motion of the ball screw 130 into a rectilineal movement, a polarity detecting sensor 150 formed on an upper portion of a nut cap 141 for covering an outside of the nut 140 and detecting a polarity of a magnet 160, the magnet 160 having polarity and formed on a lower portion of the polarity detecting sensor 150, a spring 170 formed at one side of the magnet 160, a trigger 180 coupled to the nut 140, a connecting bar 190 having one side coupled to the nut 140 and another side coupled to a movable blade 195, the movable blade 195 for moving up and down according to the rectilineal movement of the connecting bar 190, and a fixing blade 197 fixed to a case 196.

In the conventional reverse and forward direction switch, since the reverse direction is again conducted after the forward direction thereof, there is a problem in that the switch should be again operated. That is, since it cannot stop at a desired position on a branch while pruning fruit trees, there is an inconvenience that the power supply should be cut or the shears should be rapidly taken out the branch when the branch is wrongly cut.

The electric pruning shears equipped with a trigger according to the present invention is characterized in that the magnet is moved left and right according to the movement of the trigger, the polarity detecting sensor detects the magnetic polarity, the detected signal is transmitted to the control assembly, and the control assembly determines whether the corresponding signal is the reverse or forward signal, or the stop signal and transmits the determined signal to the motor assembly to operate the motor.

Generally, the magnet has a N-pole and a S-pole. However, the magnet of the present invention has N and S-poles formed at both ends thereof and any status, which is neither the N-pole nor the S-pole, formed at a center thereof. It is defined as a non-polarity in the present invention.

In case of a general magnet, the polarity detecting sensor detects only the N and S-poles and the control assembly transmits the control signals to the motor assembly so as to conduct the reverse or forward direction according to the detected signal. However, in the magnet of the present invention, the polarity detecting sensor 150 can detects the N and S-poles as well as the non-polarity, so that the control assembly 220 can also, transmit the operation stop signal to the motor assembly.

When the load is occurred while the trigger is pulled (for example, because the branch is not cut off, the trigger is continuously pulled), an over-current detecting portion detects it and then, transmits the stop signal to the motor assembly to stop the operation of the motor immediately. At this time, if the applied power is removed from the trigger, the shear blade is opened.

Accordingly, the safety of the shears can be enhanced during the operating thereof.

Here, it is preferred that the motor assembly is a slotless BLDC type motor so as to smoothly and rapidly operate the instant reverse direction when the trigger is not pulled.

Since the construction and operation method of the slotless BLDC type motor are already well-known in the art, further descriptions are omitted here.

The motor assembly 110 includes a motor shaft gear 115 formed at one side thereof and the motor shaft gear 115 is engaged with the gear assembly 120.

That is, as shown in FIG. 3, the gear assembly 120 includes three internal gears 121 fixed thereto in a triangular shape and the motor shaft gear 115 inserted into a center of three internal gears 121 and engaged with them.

More concretely, the gear assembly 120 includes three internal gears 121 and an external gear 122 for protecting the internal gears 121 and the motor is engaged with the center of the three internal gears 121.

The external gear 122 of the gear assembly 120 is coupled to the internal gears 121 so as to be smoothly rotated.

Since the operations of the three internal gears 121 and the external gear 122 for protecting the internal gears 121 are well-known in the art, further descriptions are omitted here.

After all, where the motor assembly 110 is rotated in the forward direction, the internal gears 121 are rotated in the reverse direction. On the contrary, where the motor assembly 110 is rotated in the reverse direction, the internal gears 121 are rotated in the forward direction.

Also, since the gear assembly 120 is coupled to the ball screw 130, where the internal gears 121 are rotated in the reverse direction, the ball screw 130 is rotated in the reverse direction.

As shown in the drawings, the support (not shown) for supporting the ball screw 130 includes three internal gear fixing cores 125 and the corresponding fixing cores are coupled to the internal gears 121 respectively.

Accordingly, when the internal gears 121 are rotated, the ball screw 130 is rotated in the same direction.

Also, since the nut 140 is coupled to the ball screw 130, the rotary motion of the ball screw 130 is converted into the rectilineal movement through the nut 140.

In the meantime, as shown in FIG. 3, a plurality of balls 310 is inserted into the inside of the nut 140 so as to prevent the ball screw 130 and the nut from being damaged.

That is, where the pulling and rolling movements between the ball screw 130 and the nut 140 are repeated for long hours, the threads of the ball screw 130 and the nut can be damaged or worn out. Accordingly, the plurality of balls 310 is inserted into the inside of the nut 140, so that the damage or the abrasion of the threads of the ball screw 130 and the nut 140 can be minimized.

At this time, it require any technique for prevent the plurality of balls 310 from getting out the nut. Since this technique is already well-known in the art, further descriptions are omitted here.

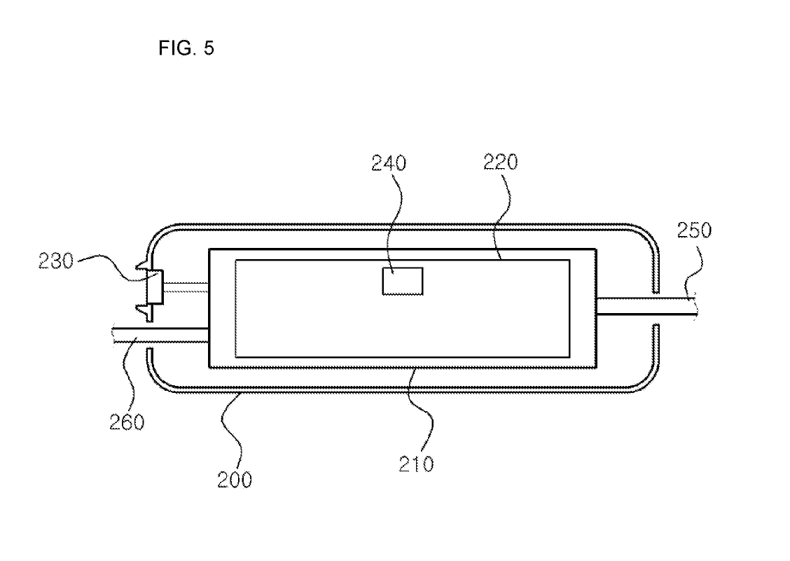

FIG. 5 is a sectional view illustrating a body of electric pruning shears equipped with a trigger according to the present invention.

As shown in FIG. 5, the body 200 includes a control assembly 220 for receiving a polarity signal detected by the polarity detecting sensor 150, determining whether the detected signal is a reverse direction, a forward direction, or an operation stop, and transmitting a forward driving signal, a reverse driving signal, or an operation stop signal to the motor assembly 110; a power switch 230, and a battery 210 for supplying a power source to the control assembly 220.

The body 200 according the present invention further includes a connector 250 formed at one side thereof and coupled to the mechanical section 100 and a charge connector 260 for charging the battery formed at another side thereof.

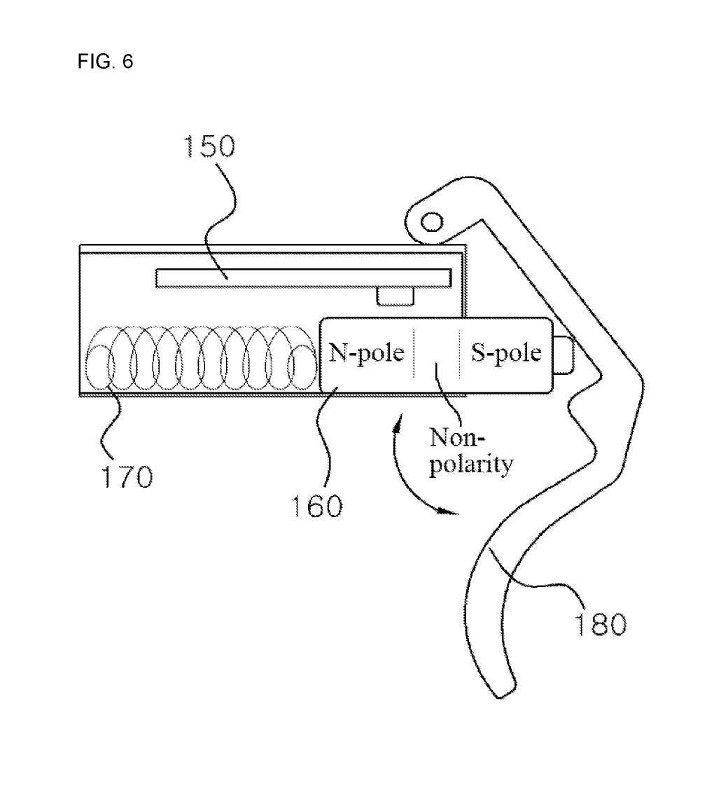

FIG. 6 is an example view illustrating a state of a magnet before a trigger according to the present invention is pulled.

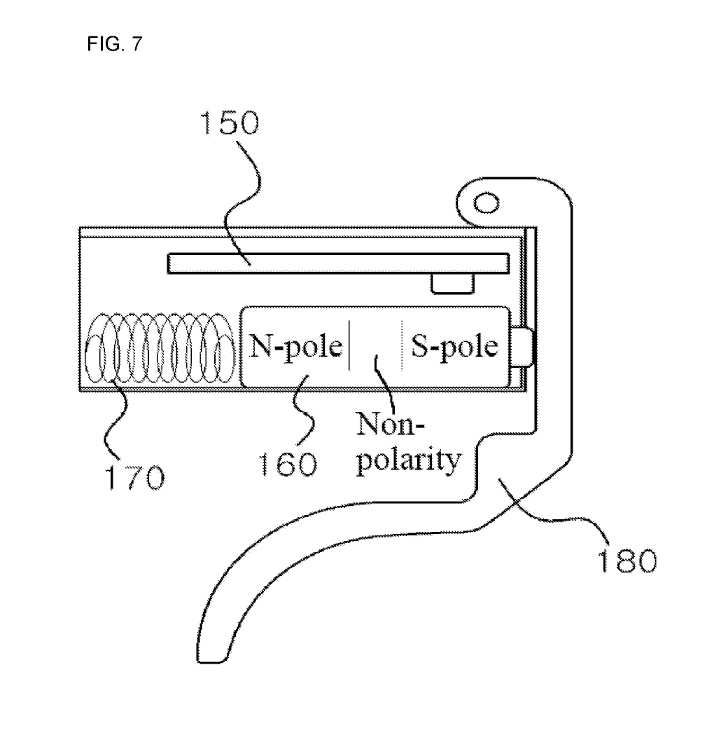

FIG. 7 is an example view illustrating a state of a magnet after a trigger according to the present invention is pulled.

As shown in FIG. 6 and FIG. 7, the mechanical section 100 of the electric pruning shears equipped with the trigger according to the present invention includes the polarity detecting sensor 150 formed on the upper portion of the nut cap 141 for covering the outside of the nut 140, the magnet 160 formed on the lower portion of the polarity detecting sensor 150, and the spring 170 formed at one side of the magnet 160. Hereinafter, the operation thereof will be described.

As shown in FIG. 6, before the trigger 180 is pulled, the polarity detecting sensor 150 detects the N-pole of the magnet 160. Also, as shown in FIG. 7, after the trigger 180 is pulled, the magnet 160 is moved to the left, so that the polarity detecting sensor 150 detects the S-pole of the magnet 160.

Accordingly, the control assembly 220 receives a polarity signal detected by the polarity detecting sensor 150, determines whether the detected signal is the reverse direction or the forward direction, and transmits the corresponding signal on the rotation to the motor assembly 110 to drive the motor assembly 110.

Here, before the trigger 180 is pulled, the polarity detecting sensor 150 detects the N-pole of the magnet 160 and then transmits the N-pole detecting signal to the control assembly 220 and the control assembly 220 transmits the forward driving signal to the motor assembly 110 to drive the motor assembly 110 in the forward direction.

At this time, during the forward rotation of the motor assembly 110, the gear assembly 120 is rotated in the reverse direction and the nut 140, which is coupled to the ball screw 130, is moved forward, so that the connecting bar 190, which is coupled to the nut 140, is also moved forward and the movable blade 195 ascends upward, thereby the blade becomes open.

As shown in FIG. 7, if the trigger 180 is pulled, the magnet 160 is moved to the left side. Accordingly, the polarity detecting sensor 150 detects the S-pole of the magnet 160 and then transmits the S-pole detecting signal to the control assembly 220 and the control assembly 220 transmits the reverse driving signal to the motor assembly 110 to drive the motor assembly 110 in the reverse direction.

At this time, during the reverse rotation of the motor assembly 110, the gear assembly 120 and the ball screw 13 are rotated in the reverse direction and the nut 140, which is coupled to the ball screw 130, is moved backward, so that the connecting bar 190, which is coupled to the nut 140, is also moved backward and the movable blade 195 descends downward, thereby the blade becomes close to cut the branch.

In the meantime, the trigger 180 can allow the movable blade 195 to stop at a desired position on the branch while pruning fruit trees. For example, if the trigger 180 is moderately pulled in order that the polarity detecting sensor 150 detects the non-polarity of the magnet 160. Accordingly, the polarity detecting sensor 150 detects the non-polarity of the magnet 160 and then transmits the non-polarity detecting signal to the control assembly 220 and the control assembly 220 transmits the operation stop signal to the motor assembly 110 to stop the driving of the motor assembly 110.

Thereafter, if it relaxes his finger, the blade becomes open.

In the meantime, the body 200 of the electric pruning shears equipped with the trigger according to another embodiment of the present invention includes the over-current detecting portion for detecting the over-current when the over-current is generated in the motor assembly 110. At this time, when the control assembly 220 receives the over-current detecting signal through the over-current detecting portion, it transmits the operation stop signal to the motor assembly 110.

In case of a big branch, since the over-current is flowed through the motor assembly 110, the control assembly 220 detects the over-current and transmits the operation stop signal to the motor assembly 110 to stop the driving of the motor assembly 110.

In the meantime, the body 200 of the electric pruning shears equipped with the trigger according to another embodiment of the present invention includes a display portion 240 for displaying the residual quantity of the battery 210.

That is, since it can check the residue quantity of the battery 210, the charge time can be informed, thereby providing convenience thereof to the worker.

As described above, instead of the conventional forward and reverse operating switch, the magnet coupled to the trigger can be moved in accordance with the operation of the trigger through the user, so that the trigger could operate the motor assembly by detecting magnetic polarity with the polarity detecting sensor, transmitting the operating signal in accordance with the polarity to the control assembly, determining whether the corresponding signal is in the reverse or forward direction, and transmitting the determined reverse driving signal or forward driving signal to the motor assembly to operate a motor, and also the trigger allows a movable blade to stop at a desired position on a branch while pruning fruit trees by stopping the operation of the motor if the polarity detecting sensor realizes the magnetic center.

Also, where the branch is not cut during working thereof, the overload is occurred. At this time, the control assembly detects it and then, transmits the operation stop signal to the motor assembly to stop the driving of the motor assembly, thereby it can prevent the control assembly, the battery, and the motor assembly from being damaged. Moreover, the gear assembly is coupled to the ball screw and the plurality of balls is inserted into the inside of the nut for converting the rotary motion of the ball screw into the rectilineal movement, so that it can prevent the ball screw and the nut from being damaged. Furthermore, the body includes the display portion, so that the residual quantity of the battery can be displayed, thereby it can provide the charge time to the worker.

Although several exemplary embodiments of the present invention have been described for illustrative purposes, those skilled in the art will appreciate that various modifications, additions and substitutions are possible, without departing from the scope and spirit of the invention as disclosed in the accompanying claims.

The present invention relates to electric pruning shears equipped with a trigger, wherein instead of the conventional forward and reverse operating switch, the magnet coupled to the trigger can be moved in accordance with the operation of the trigger through the user, so that the trigger could operate the motor assembly by detecting magnetic polarity with the polarity detecting sensor, transmitting the operating signal in accordance with the polarity to the control assembly, determining whether the corresponding signal is in the reverse or forward direction, and transmitting the determined reverse driving signal or forward driving signal to the motor assembly to operate a motor, and also the trigger allows a movable blade to stop at a desired position on a branch while pruning fruit trees by stopping the operation of the motor if the polarity detecting sensor realizes the magnetic center. Accordingly, the electric pruning shears equipped with the trigger according to the present invention can be widely utilized in the field of the electric pruning shears.

1. Electric pruning shears equipped with a trigger comprising:
a mechanical section comprising a motor assembly having a motor shaft gear formed at one side thereof, a gear assembly interlocked with the motor shaft gear, a ball screw coupled to the gear assembly and rotated in a conrotatory direction of the gear assembly, a nut coupled to the ball screw and converting a rotary motion of the ball screw into a rectilineal movement, a polarity detecting sensor formed on an upper portion of a nut cap for covering an outside of the nut and detecting a polarity of a magnet, the magnet having polarity and formed on a lower portion of the polarity detecting sensor, a spring formed at one side of the magnet, a trigger coupled to the nut, a connecting bar having one side coupled to the nut and another side coupled to a movable blade, the movable blade for moving up and down according to the rectilineal movement of the connecting bar, and a fixing blade fixed to a case; and
a body comprising a control assembly for receiving a polarity signal detected by the polarity detecting sensor, determining whether the detected signal is a reverse direction, a forward direction, or an operation stop, and transmitting a forward driving signal, a reverse driving signal, or an operation stop signal to the motor assembly; a power switch; and a battery for supplying a power source to the control assembly.

2. Electric pruning shears equipped with a trigger comprising:
a mechanical section comprising a motor assembly having a motor shaft gear formed at one side thereof, a gear assembly interlocked with the motor shaft gear, a ball screw coupled to the gear assembly and rotated in a conrotatory direction of the gear assembly, a nut coupled to the ball screw and converting a rotary motion of the ball screw into a rectilineal movement, a polarity detecting sensor formed on an upper portion of a nut cap for covering an outside of the nut and detecting a polarity of a magnet, the magnet having polarity and formed on a lower portion of the polarity detecting sensor, a spring formed at one side of the magnet, a trigger coupled to the nut, a connecting bar having one side coupled to the nut and another side coupled to a movable blade, the movable blade for moving up and down according to the rectilineal movement of the connecting bar, and a fixing blade fixed to a case; and
a body comprising a control assembly for receiving a polarity signal detected by the polarity detecting sensor, determining whether the detected signal is a reverse direction, a forward direction, or an operation stop, and transmitting a forward driving signal, a reverse driving signal or an operation stop signal to the motor assembly, or transmitting an operation stop signal to the motor assembly when an over-current detecting signal is received from an over-current detecting portion; a power switch; a battery for supplying a power source to the control assembly; and the over-current detecting portion for detecting the over-current when the over-current is generated in the motor assembly.

3. Electric pruning shears equipped with a trigger comprising:
a mechanical section comprising a motor assembly having a motor shaft gear formed at one side thereof, a gear assembly interlocked with the motor shaft gear, a ball screw coupled to the gear assembly and rotated in a conrotatory direction of the gear assembly, a nut coupled to the ball screw and converting a rotary motion of the ball screw into a rectilineal movement, a polarity detecting sensor formed on an upper portion of a nut cap for covering an outside of the nut and detecting a polarity of a magnet, the magnet having polarity and formed on a lower portion of the polarity detecting sensor, a spring formed at one side of the magnet, a trigger coupled to the nut, a connecting bar having one side coupled to the nut and another side coupled to a movable blade, the movable blade for moving up and down according to the rectilineal movement of the connecting bar, and a fixing blade fixed to a case; and
a body comprising a control assembly for receiving a polarity signal detected by the polarity detecting sensor, determining whether the detected signal is a reverse direction, a forward direction, or an operation stop, and transmitting a forward driving signal, a reverse driving signal or an operation stop signal to the motor assembly, or transmitting an operation stop signal to the motor assembly when an over-current detecting signal is received from an over-current detecting portion; a power switch; a battery for supplying a power source to the control assembly; the over-current detecting portion for detecting the over-current when the over-current is generated in the motor assembly; and a display portion for displaying the residual quantity of the battery.

4. Electric pruning shears equipped with a trigger as recited in claim 1, wherein a connector is constructed to the body and the mechanical section and the body is coupled to and separated from the mechanical section through a connector cable.

5. Electric pruning shears equipped with a trigger as recited in claim 1, wherein the motor assembly is a slotless BLDC type motor so as to smoothly and rapidly operate an instant reverse direction when the trigger is not pulled.

6. Electric pruning shears equipped with a trigger as recited in claim 1, wherein a plurality of balls is inserted into the inside of the nut so as to prevent the ball screw and the nut from being damaged.

7. Electric pruning shears equipped with a trigger as recited in claim 1, wherein the control assembly transmits the forward driving signal to the motor assembly when the polarity detected by the polarity detecting sensor is a N-pole, and transmits the reverse driving signal to the motor assembly when the polarity detected by the polarity detecting sensor is a S-pole.

8. Electric pruning shears equipped with a trigger as recited in claim 1, wherein the control assembly transmits the forward driving signal to the motor assembly when the polarity detected by the polarity detecting sensor is a N-pole, transmits the reverse driving signal to the motor assembly when the polarity detected by the polarity detecting sensor is a S-pole, and transmits the operation stop signal to the motor assembly when the polarity detected by the polarity detecting sensor is a non-polarity.

9. Electric pruning shears equipped with a trigger as recited in claim 1, wherein the gear assembly comprises three internal gears and an external gear for protecting the internal gears and the motor shaft gear is engaged with the center of the three internal gears.

10. Electric pruning shears equipped with a trigger comprising:
a mechanical section comprising a gear assembly coupled to a shaft of a motor assembly attached to a case, a nut for converting a rotary motion of the gear assembly into a rectilineal movement, a magnet moved left and right according to a movement of a trigger, and a polarity detecting sensor for detecting a polarity of the magnet and transmitting a detected polarity signal to a control assembly; and
a body comprising a control assembly for receiving the polarity signal detected by the polarity detecting sensor, determining whether the detected signal is a reverse direction, a forward direction, or an operation stop, and transmitting a forward driving signal, a reverse driving signal, or an operation stop signal to the motor assembly; a power switch; and a battery for supplying a power source to the control assembly.

11. Electric pruning shears equipped with a trigger comprising:
a mechanical section comprising a gear assembly coupled to a shaft of a motor assembly attached to a case, a nut for converting a rotary motion of the gear assembly into a rectilineal movement, a magnet moved left and right according to a movement of a trigger, and a polarity detecting sensor for detecting a polarity of the magnet and transmitting a detected polarity signal to a control assembly; and
a body comprising a control assembly for receiving the polarity signal detected by the polarity detecting sensor, determining whether the detected signal is a reverse direction, a forward direction, or an operation stop, and transmitting a forward driving signal, a reverse driving signal or an operation stop signal to the motor assembly, or transmitting an operation stop signal to the motor assembly when an over-current detecting signal is received from an over-current detecting portion; a power switch; a battery for supplying a power source to the control assembly; and the over-current detecting portion for detecting the over-current when the over-current is generated in the motor assembly.

12. Electric pruning shears equipped with a trigger as recited in claim 10, wherein the control assembly transmits the forward driving signal to the motor assembly when the polarity detected by the polarity detecting sensor is a N-pole, and transmits the reverse driving signal to the motor assembly when the polarity detected by the polarity detecting sensor is a S-pole.

13. Electric pruning shears equipped with a trigger as recited in claim 10, wherein the control assembly transmits the forward driving signal to the motor assembly when the polarity detected by the polarity detecting sensor is a N-pole, transmits the reverse driving signal to the motor assembly when the polarity detected by the polarity detecting sensor is a S-pole, and transmits the operation stop signal to the motor assembly when the polarity detected by the polarity detecting sensor is a non-polarity.

14. Electric pruning shears equipped with a trigger as recited in claim 10, wherein the gear assembly comprises three internal gears and an external gear for protecting the internal gears and the motor shaft gear is engaged with the center of the three internal gears.
